(19) United States
(12) Patent Application Publication
(10) Pub. No.: US 2006/0194608 A1
(43) Pub. Date: Aug. 31, 2006

(54) Remote cellular receiver

(76) Inventors: Joel F. Lemke, San Diego, CA (US); Christopher J. Goger, Los Angeles, CA (US)

Correspondence Address: FULWIDER PATTON, 6060 CENTER DRIVE, 10TH FLOOR, LOS ANGELES, CA, 90045, US

(21) Appl. No.: 10/773,355

(22) Filed: Feb. 5, 2004

Related U.S. Application Data
(60) Provisional application No. 60/445,367, filed on Feb. 5, 2003.

(51) Int. Cl. H04Q 7/20; H04M 1/00

(52) U.S. Cl. 455/552.1; 455/462

(57) ABSTRACT

A cellular telephone system and assembly that provides the quality of reception and convenience of a standard telephone without the requiring telephone cable hookup to a telephone line provider. Components of the cellular telephone assembly can include a cellular receiver and transmitter assembly, a filter and amplifier assembly, a cellular-to-cable converter assembly and a power supply. Moreover, the telephone system can embody a cellular telephone in combination with one or more remote cellular receivers.

This application is based upon provisional U.S. Application Ser. No. 60/445,367.

This invention relates generally to cellular telephones. More particularly, the invention relates to cellular telephones with amplifier, filter and converter assemblies as well as telephone systems including cellular telephones and remote cellular receivers.

### BACKGROUND OF THE INVENTION

Cellular telephones have become universally accepted as a portable means of communication. It is estimated that one in every five people, between the ages of 14 and 70 in the United States, owns a cellular telephone. Size and weight of these cellular devices have, since their inception in the late twentieth century, continually diminished where today they are smaller than the palm of the hand of the user and weigh less than a pound. This, in conjunction with the introduction of the digital to replace the analog cellular telephone, has contributed to the increased popularity towards these devices. Users of cellular telephones can be in communication with virtually anyone, anywhere they happen to be.

This popularity and convenience, however, does not come without its disadvantages and limitations. When a user purchases a cellular telephone service contract, they are assigned a unique telephone number which provides access to that particular cellular telephone. This means a separate telephone service bill. A typical cellular user will therefore have at least two telephone numbers, one wire connected service at their home and the cellular number. Often the user will have a third office telephone number. This means two, or three, telephone service bills each month. And, if the user has one local service carrier and a different long distance service carrier, each of the wire connected telephone services will represent two telephone bills.

Another disadvantage of current cellular telephones lies within their design restrictions. FCC regulations, which dictate a narrow bandwidth and limited signal strength, limit the quality of communication that can be received by a cellular telephone. The digital cellular design certainly has improved the quality of signal, but even the most sophisticated design digital cellular telephone today cannot approach the quality of signal derived from a wire connected telephone.

Of course, the inherent mobility of the cellular telephone provides the very positive advantage over a wire connected telephone in that when the user moves he/she does not need to disconnect the cellular service and reconnect with perhaps a different provider, with all the costs and inconveniences involved therein.

Moreover, with the entry of the cellular telephone into nearly everybody's everyday life patterns, the “wire-connected” family telephone is becoming extinct. The one household, one telephone number environment is becoming a phenomena of the past. Each family member has his or her own cellular telephone number, each with its own distinct telephone number. Under new FCC Rulings these telephone numbers go with an individual wherever they move—no longer does a new address mean a new telephone number. Realizing this fact, it can become difficult to justify paying monthly bills for a wire connection to the home in addition to paying a monthly cellular bill. This of course also applies to businesses as well, especially a sales organization or an organization supported by multiple transient or satellite offices.

Accordingly, with these disadvantages and limitations involved with current technology telephone service, there exists a need for a telephone system that provides the mobility of the cellular telephone with the quality of received messages inherent in the wire connected telephone, and/or the so called “wireless” telephone, found in homes and offices of today. There is also a need for a telephone system that eliminates the duplication associated with the conventional land line and cellular multiple plans without sacrificing convenience. The present invention addresses these and other needs.

### INVENTION SUMMARY

Briefly and in general terms, the present invention is directed towards a cellular telephone assembly that exhibits wire connected quality communication reception within the home or office environment without the inconvenience and expense a cable telephone service provider. The cellular telephone assembly, of the present invention, comprises a cellular receiver and transmitter assembly, a filter/amplifier assembly, a cellular-to-cable signal converter assembly and a power supply assembly housed within a single assembly.

In one preferred embodiment of the cellular telephone assembly the cellular receiver and transmitter assembly has no microphone, no speaker, no battery and is powered by the internal power supply. An antenna, attached to the outside of the cellular telephone assembly and connected to the receiver/transmitter assembly, receives and transmits signals to/from the cellular receiver/transmitter assembly. Received signals are sent to the filter/amplifier assembly wherein background noise and static are filtered out and the resulting signal is then amplified. This filtered and amplified signal is then connected to the cellular-to-cable converter where it is modulated onto a −75 volt DC signal from the power supply assembly. This converted cellular-to-cable signal thereby duplicates the signal normally received from the cable telephone provider and is connected to a standard telephone jack receptacle on the outside surface of the cellular telephone assembly. A standard telephone jack cable then connects the cellular telephone assembly to a standard cable telephone, “wireless” telephone or any standard telephone/answering machine combination. With any standard telephone, the user now enjoys the signal quality of a cable connected telephone without the need of being connected to, and paying for, a cable telephone provider. Also, when the user connects the cellular telephone assembly to a standard wireless telephone he/she also enjoys the full mobility of a cellular telephone throughout the house or office, but with the signal quality of a cable connected telephone.

In another embodiment of the present invention the cellular telephone assembly, as described in the preferred embodiment above, would be housed within a standard configuration telephone assembly, wireless or not, with or without included answering machine. In this configuration no cable would be required other than a standard AC power cable and plug.

Other configurations of either of the above described configurations could include a connector for plugging in a hand-held cellular telephone for charging its internal battery, or multiple plugs for charging more than one cellular telephone at a time.

Still other configurations could include mobile telephone booths for special events, such as sports or concerts, wherein no provider connection line would be required. Standard telephone quality communication on board private boats or within campers. The options are limited only by the imagination of the user.

In a related application, the present invention embodies a telephone system including a cellular telephone in combination with one or more remote cellular receivers. In one aspect of the invention and to minimize cost, voice data is sent from a cellular telephone to the remote cellular receiver and from the remote cellular receiver through the cellular telephone to the location to which the cellular telephone is connected, but external calls cannot be placed from the remote cellular receiver. Additionally, a ring signal is sent from the cellular telephone to each of the remote cellular receivers which in turn causes the receiver to signal that a call has been received by the cellular telephone. Also, the remote cellular receiver contains a transmitter which sends a pick-up signal to the cellular telephone when a call is being handled by the receiver as well as sends a disconnect signal to the cell phone when a call is terminated.

In other aspects, the telephone system further includes a re-charging unit and cellular cradle which receives and recharges a cellular telephone. The cellular cradle communicates with one or more remote cellular receivers sending a ring signal to the remote receivers. Moreover, the telephone systems can include multiple re-charging and cellular cradle units that can either be stand alone systems or systems which are networked so that a call to a first cell phone can be picked up by any remote cellular receiver. Further, the remote cellular receivers can be configured so that multiple receivers can be accessed simultaneously so that a plurality of persons can participate in a single call.

In one preferred embodiment, the remote cellular receivers include a handset which is easy and comfortable to use. Rather than a need for minimal size as is a desired characterization of a cellular telephone, the handsets can be relatively larger. In other aspects, each remote cellular receiver can include a distinctive ring or the capability to alter its ring so as to be identifiable with one particular cell phone. Additionally, the remote receivers can also include a recharging unit that recharges a cordless handset.

Other features and advantages of the present invention will become apparent from the following detailed description taken in conjunction with the accompanying drawings, which illustrate, by way of example, the principles of the invention.

### BRIEF DESCRIPTION OF THE DRAWINGS

FIG. 1 is a perspective view, depicting the relationship between a prior art wire connected telephone assembly and a hand held cellular telephone;

FIG. 2 is a perspective view depicting the relationship between the current invention cellular telephone assembly and a hand held cellular telephone;

FIG. 3 is a block diagram of a preferred embodiment of the cellular telephone assembly; and

FIG. 4 is a perspective view depicting another embodiment wherein the cellular telephone assembly is incorporated into a standard telephone assembly.

FIG. 5 is a perspective view, depicting one embodiment of a cellular cradle and recharging unit;

FIG. 6 is a perspective view, depicting an end view of a conventional cellular telephone;

FIG. 7 is a perspective view, depicting one embodiment of a remote cellular receiver;

FIG. 8 is a schematic block diagram, depicting the operation of a cellular cradle and recharging unit; and

FIG. 9 is a schematic block diagram, depicting the operation of a remote cellular receiver.

### DETAILED DESCRIPTION OF THE PREFERRED EMBODIMENTS

Referring now to the drawings, which are provided for example and should not be construed as a limitation, the present invention is embodied in a cellular telephone assembly designed to efficiently provide quality communication without the necessity of a telephone cable provider. The cellular telephone assembly comprises a cellular receiver and transmitter assembly (CRTA), a filter/amplifier assembly (FAA), a cellular-to-cable converter assembly (CCCA) and a power supply assembly (PSA) configured in a single assembly.

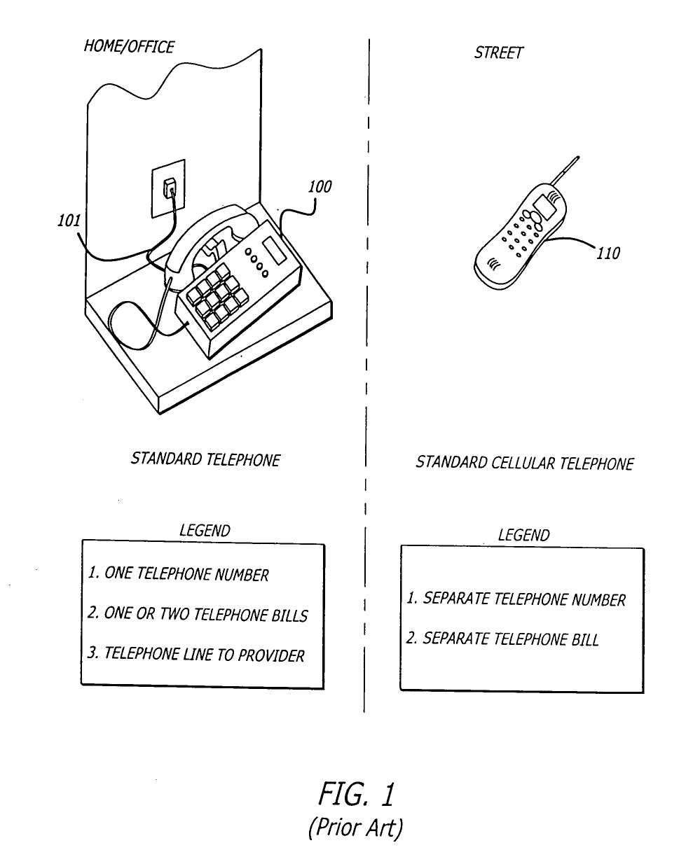

Referring now to FIG. 1, there is depicted the relationship between a prior art standard cable telephone assembly 100 and a hand-held cellular telephone 110. In this environment there exists the need for a telephone cable 101 connected to a cable provider network, at least two separate telephone numbers and therefore two separate telephone bills. If the user in this environment uses one telephone provider for local call and a different provider for long distant call, then there can be three telephone bills. And, if the user in this environment has a business telephone with yet another telephone number there can be up to five separate telephone bills each month.

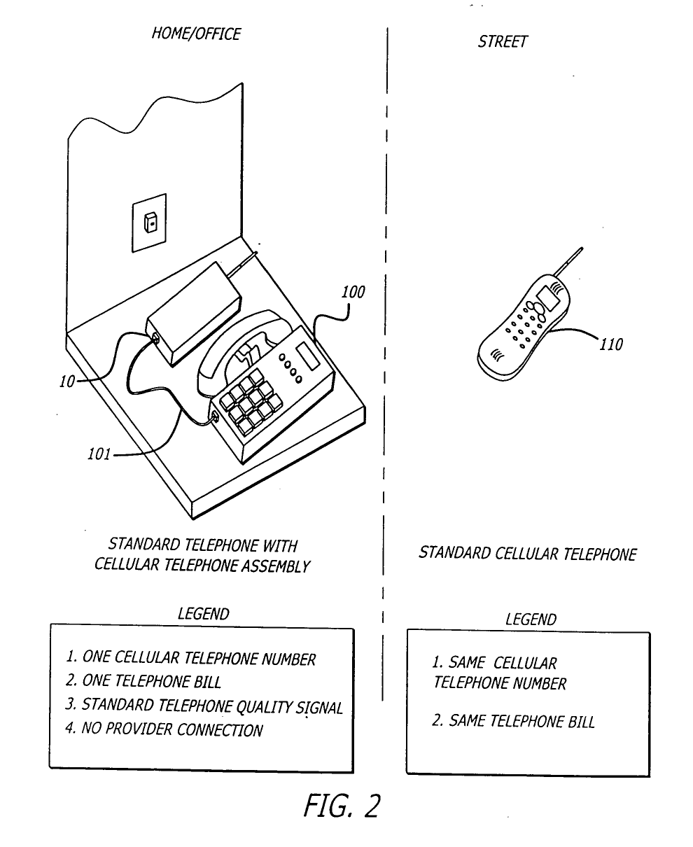

FIG. 2 depicts the relationship between the preferred embodiment of the present invention cellular telephone assembly 10 and a hand-held cellular 110. In this environment there is no need for a cable 101 connected to a telephone line provider network. There is only one telephone number for both the cellular telephone assembly 10 and the hand-held cellular telephone 110. There is no need for separate providers for local and long distance telephone calls. And, an office telephone could have the same cellular telephone number, all of which means only one telephone bill. Also, in this environment, if a standard wireless telephone is employed the user enjoys the full quality of a standard cable connected telephone in his or her home and office with the full mobility of a cellular telephone.

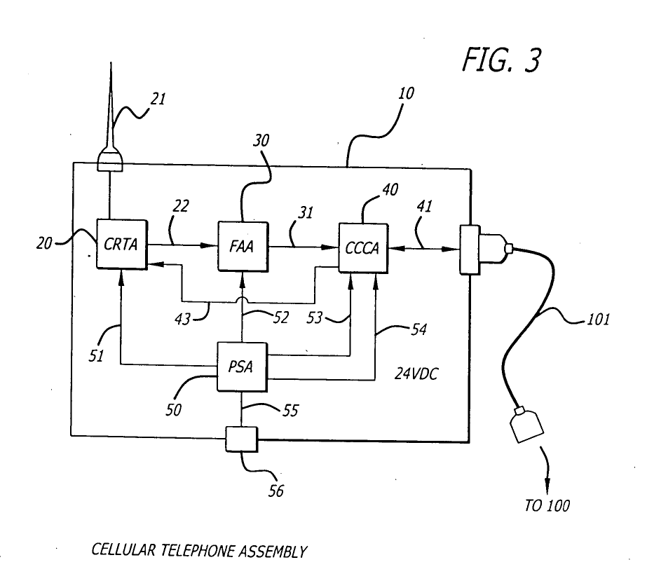

Looking now at FIG. 3, we see a block diagram of the preferred embodiment of the cellular telephone assembly 10. The CRTA 20 is a basic cellular receiver and transmitter with no microphone or speaker. An antenna 21 connected to the CRTA receives and transmits cellular signals from the cellular telephone assembly 10. Received signals are sent from the CRTA 20 to the FAA 30 by line 22. The FAA 30 filters background noise and static received by the CRTA 20 and then amplifies the resultant signal for improved quality of reception. This enhanced signal is then connected through line 31 to the CCCA 40 where the signal is modulated and offset by −75 VDC which is supplied from the Power supply (PSA) 50 through line 54. This offset, modulated signal duplicates the signal that a telephone line provider would supply from a wall telephone jack. It thereby has converted the cellular signal to what appears to be a standard telephone line signal. A line 41 connects this signal to a standard telephone jack connector 42 which is mounted to the outside surface of the cellular telephone assembly 10. A standard telephone jack cable 101 then connects the cellular telephone assembly 10 to a standard telephone, or wireless telephone, assembly 100. The PSA 50 provides power to the CRTA 20 through line 51, the FAA 30 through line 52 and the CCCA 40 through lines 53. The 24 VDC offset voltage from the PSA the 50 to the CCCA 40 is provided through line 54. A cable 55 connects the PSA 50 to a standard AC power receptacle 56 mounted on the outside of the cellular telephone assembly 10.

When the user talks into the standard telephone assembly 100 (not shown in FIG. 3) the voice signal, offset by the −75 VDC, is sent through the standard telephone jack cable 101, jack receptacle 42 and line 41 to the CCCA 40 where the −75 VDC offset signal is removed. This converted signal is then connected directly to the CRTA 20 transmitter through line 43 where it is then transmitted, as a cellular signal, through antenna 21.

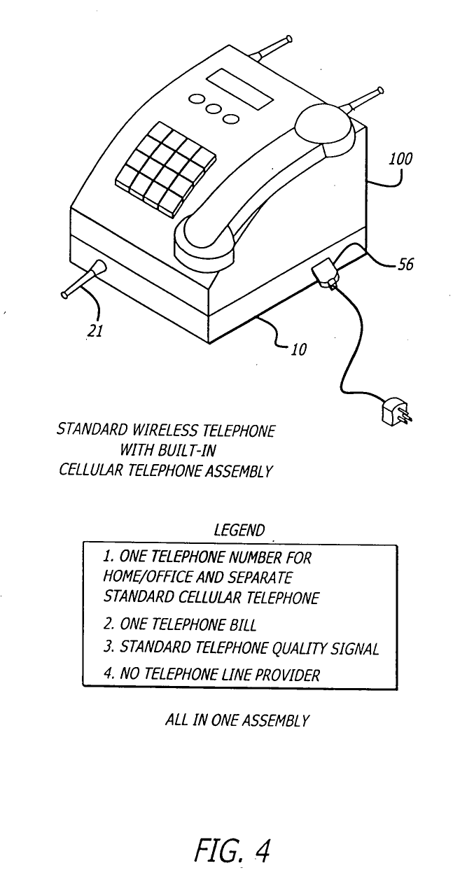

FIG. 4 depicts an alternate embodiment of the current invention wherein the cellular telephone assembly 10 is built into a standard telephone, or wireless telephone, assembly 100 as a stand-alone device. In this embodiment, all elements described above apply, except for the need of an interconnecting telephone jack cable 101.

In a related application, the present invention is directed towards eliminating duplication associated with multiple telephone plans. Rather than having both a conventional land line and a cellular phone, a telephone system including just the cellular phone is contemplated.

In one embodiment, the telephone system would include a cell phone that communicates with one or more remote cellular receivers. The remote cellular receivers can be placed throughout a home or office as is convenient and the cell phone is contemplated to be placed at a central location from which calls can be made. The design of the handset of the remote cellular receivers can mimic that of any conventional land line telephone handset with the exception that no dial-out keys are present. In this way, most of the features of a conventional land line system are replaced by the combination of the cell phone and remote receiver systems.

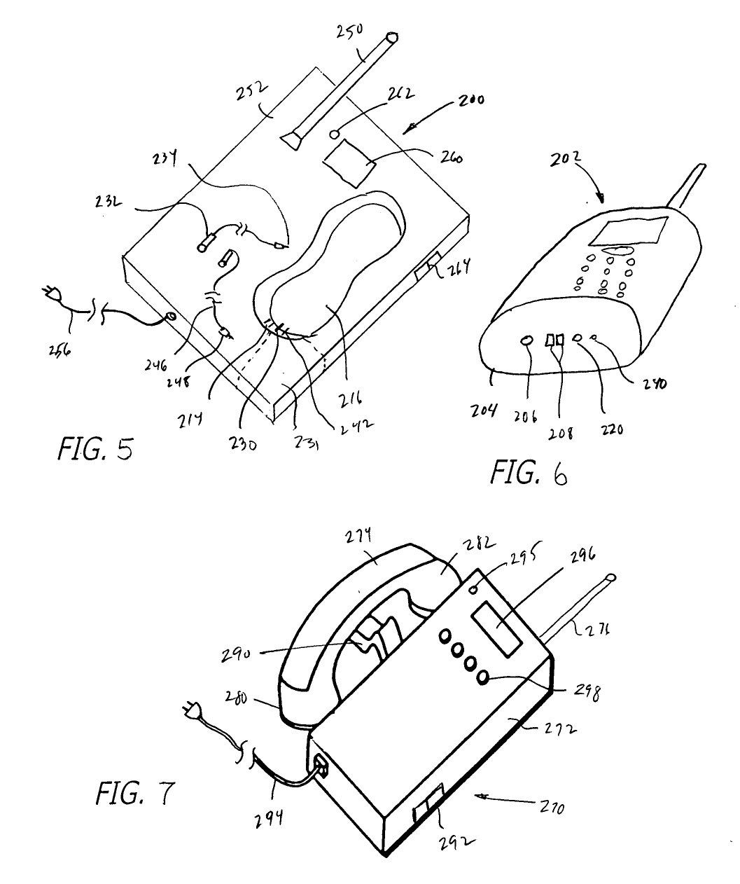

More particularly, with reference to FIGS. 5 and 6, there is shown one embodiment of a cellular cradle and recharging unit 200 for a conventional cellular telephone 202. The conventional cell phone 202 includes a number of features which facilitate communication with the cellular cradle and recharging unit 200. As shown in FIG. 5, a base 204 of the cell phone 202 includes a charger port 206 as well as cellular cradle charger contacts 208. Each of these provide an avenue to charge a battery (not shown) of a typical cell phone 202. The charger port 206 for example, is adapted to be connected to a conventional transformer assembly (not shown) that plugs into a wall outlet. The cellular cradle charger contacts 208 are designed to engage like contacts of a charging unit such as the contacts 214 depicted in a cell phone well 216 of the cellular cradle and recharging unit 200. Through circuitry provided within the cellular cradle and recharging unit 200, recharging power is provided to the contacts 214 and in turn to the cell phone 202 battery (not shown).

A cell phone 202 also typically includes a headset port 220 that is adapted to receive a plug-in connector attached to a headset. In the present invention, the cell phone well 216 is equipped with a headset port access pin 230 that is configured to be aligned with and provide a communication channel with the cell phone 202. Since various cell phones can have alternate arrangements and locations for the headset port 220, the cellular cradle and recharging unit 200 can alternatively include a cut-out 231 (shown by dashed lines) providing access to the headset port 230 when the cell phone 202 is placed within the well 216. In such an arrangement, the cellular cradle and recharging assembly 200 would lack the headset port access pin 230 and instead include a headset lead 232 with a headset plug 234 to thereby provide the described communication channel with the cell phone 202.

Alternatively, the cellular cradle and recharger assembly 200 can include both types of apparatus for accessing the headset port as the cutout 231 can be removable as necessary. Moreover, various different cutouts having different spacing and sized pins are contemplated so that many cellular phones can be accommodated. Of course, the cutout 231 would include the necessary conventional plug-ins to removably connect to the circuitry of the cellular cradle and recharger assembly 200.

The conventional cell phone 202 also includes a cellular telephone activation jack 240. Access to circuitry associated with the telephone activation jack 240 is provided by an activation pin 242 configured with the cell phone well 216. Again, the pin 242 can be replaced or supplemented by a lead 246 and plug 248 arrangement, access to the cellular telephone activation jack 240 being possible by removing the cutout assembly 231.

As shown in FIG. 5, the cellular cradle and recharger assembly 200 further includes an antennae 250 extending from a base 252. In one embodiment, the antennae is configured to both transmit and receive RF signals. Also, the cellular cradle and recharger assembly 200 includes a conventional plug assembly 256 adapted to be received in a common wall plug. Various other features are also contemplated such as a display 260 indicating time, the date and/or caller identification information. The assembly can also include a power indicator 262 and an on/off switch 264.

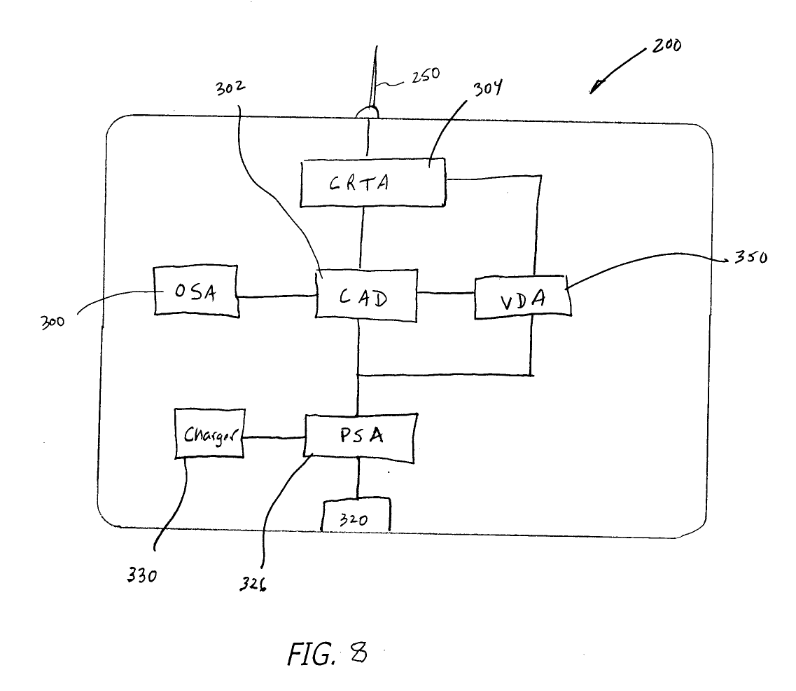

With reference now to FIG. 7, there is shown one embodiment of a remote cellular receiver 270. Various shapes and sizes of the components of the remote cellular receiver 270 are contemplated. The remote cellular receiver 270 includes a base 272 and a handset 274. Although shown as the base 272 including an antennae 276, the handset 274 itself can be equipped with the antennae or both components can include such structure.

In one embodiment, the handset 274 is designed to be easy and comfortable to use. More specifically, the distance between a mouth piece 280 and a hearing apparatus 282 is chosen so that the handset 274 comfortably fits most users. The handset 274 can be connected to the base 272 via a cable (not shown) or alternatively, can be a portable phone that communicates with the base 272 via a RF signal. Where the handset 274 is portable, the remote cellular receiver can further include a recharger like that of the cellular cradle and recharging assembly 200 for the cell phone 202.

The base 272 can include a cellular cradle 290 for receiving and holding the handset 280. The base 272 can further include a power on/off switch 292 and a power cord 294 that connects to a conventional wall outlet. A power indicator 295 as well as a display 296 are also contemplated features. Using conventional circuitry, the display can provide date and time information as well as information regarding the cell phone to which the remote cellular receiver 270 is connected.

For example, it is further contemplated that a telephone system can be designed that includes a remote cellular receiver that handles a number of different cell phones. Buttons 298 can access circuitry which switches the remote cellular receiver 220 between the various cell phones connected to the system. A different ring or tone can be associated with each cell phone so that it can be known at once which cell phone is receiving a call. These buttons can further include an LED indicating which line is receiving a call.

Turning now to FIG. 8 in conjunction with FIGS. 5-7, the operation of a telephone system embodying one or more cellular telephones and one or more remote cellular receivers is described. In use, the cellular phone 202 is placed in the cellular cradle and recharging assembly 200 to recharge and to be in communication with one or more remote cellular receivers 270. The cell phone 202 is so placed with its power on. When a telephone call is being made to the cell phone 202, a signal is sent from the cell phone 202 via the cellular telephone activation jack 240 (See FIG. 6) to an ON/OFF signal assembly (OSA) 300. The OSA 300 then transmits a message to a cell phone activation decoder (CAD) 302 which in turn sends an impulse indicating that a call is being received to a cellular receiver and transmitter assembly (CRTA) 304. Through its connection to the recharger antennae 250, the CRTA signal is transmitted via RF energy to one or more remote cellular receivers 270.

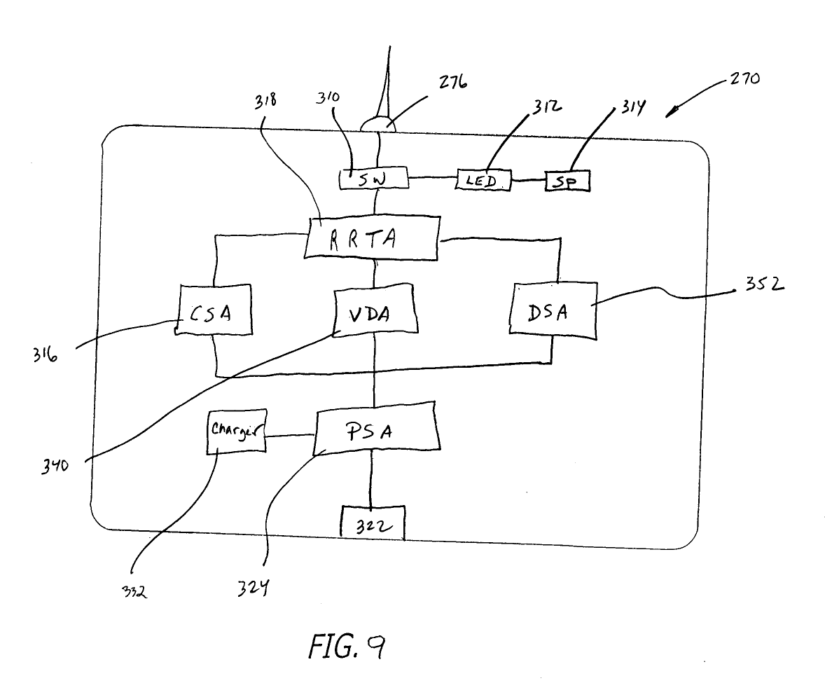

With reference to FIGS. 8 and 9, the remote cellular receiver(s) 270 in communication with the cell phone cradle and recharging assembly 200 receive the RF signal indicating that a call is being received, which is accepted by the remote cellular receiving antennae 276. The call signal can be transmitted through a switch 310, depending on whether the telephone system is designed to handle one or more cell phones. Should the system be set up to handle multiple cell phones, the signal will cause an LED 312 of an un-engaged button 298 (See FIG. 7) to light up and/or the remote cellular receiver to ring via a speaker 314. Various rings can be provided and associated or controlled by switch 312 to distinguish between cell phones. Means can also be provided to control the volume of the ring.

Once the remote cellular receiver is accessed for example, by lifting the handset 284 from the cellular cradle 290 or otherwise pressing an ON or talk button (not shown), a connect signal assembly (CSA) 316 is activated. The CSA then sends a signal to a remote receiver and transmitter assembly (RRTA) 318 which then transmits a connect message via RF waves from the antennae 276 of the remote cellular receiver 270 to the cellular cradle and recharging unit 200. This connect message is received by the recharging unit antennae 250 through the CRTA 304, CAD 302 and OSA 300 to tell the cell phone 202 that the call is being taken by the remote receiver 270.

Power provided from a connection to a wall outlet via a hook-up 320 to the cellular cradle and recharging unit 200 or via a hook-up 322 to the remote cellular receivers 270 is processed by a power supply assembly 324, 326. As stated, the cellular cradle and recharger unit 200 and the receivers 270 can each further include a charger assembly 330, 332 for charging a cell phone 202 and a portable handset 374.

After a user activates the handset 274 of the receiver unit 270, she can begin talking through the mouthpiece 280. Voice data is sent through the mouthpiece through its connection to a voice data assembly (VDA) 340 and the RRTA and receiver antennae 276 to the cellular cradle and recharging unit 200. The recharging unit antennae 250 receives the voice data via RF energy, the corresponding signal being processed by the recharging unit CRTA 304 and through a voice data assembly (VDA) 350 of the recharging unit. The VDA 350 is connected to the cell phone 202 through the headset port 220 to thereby provide a communication route to participate in a telephone call.

At the conclusion of a call, the handset 274 of the remote receiver 270 is returned to the cellular cradle 290 (or an off/talk button is depressed) to end a call. At this point, a disconnect signal assembly (DSA) 352 is activated which in turn sends an end call signal to the RRTA 318 which is transmitted to the CRTA 304 of the remote receiver 270. The CRTA 304 then communicates with the CAD 302 and OSA 300 to instruct the cell phone 202 to terminate the phone call.

As mentioned previously, the subject telephone system can accommodate a plurality of cell phones which are associated with one or a plurality of remote cellular receivers. In this way, one or more cell phones can be placed in its respective charging unit located in a central location such as a kitchen. These cell phones can then communicate with a single or multiple remote cellular receivers positioned throughout a home or office. When a call is received, a particular receiver can be picked up to answer a call associated with a specific cell phone or if equipped with a switch system, the receiver can answer any of the cell phones which are part of the system. To minimize device cost, the receivers are not contemplated to be equipped with an ability to initiate a call, however, such a capability can also be added if desired.

Thus, it will be apparent from the foregoing that, while particular forms of the invention have been illustrated and described, various modifications can be made without parting from the intent and scope of the invention, as herein set forth. As an example, the cellular telephone assembly 10 could be configured into virtually any shape housing assembly so as to enhance its marketability. It could be a figure, an automobile, a train, the options are boundless.

While the specification describes particular embodiments of the present invention, those of ordinary skill can devise variations of the present invention without departing from the inventive concept.

We claim:

1. A telephone assembly, comprising:
a cellular telephone;
a charging unit, the charging unit adapted to receive and charge the cellular telephone; and
at least one remote cellular receiver, the remote cellular receiver including a handset capable of communicating with the cellular telephone.

2. The telephone system of claim 1, wherein the at least one remote cellular receiver receives an RF signal carrying voice data originating from the cellular telephone.

3. The telephone system of claim 2, the at least one remote cellular receiver further includes a subassembly that is capable of remotely receiving a transmission sent to the cellular telephone.

4. The telephone system of claim 3, wherein the remote cellular receiver lacks an ability to initiate a telephone call.

5. The telephone system of claim 1, further comprising at least one additional cellular telephone.

6. The telephone system of claim 5, further comprising at least one additional remote cellular receiver.

7. The telephone system of claim 6, wherein the at least one remote cellular receiver can communicate only with the cellular telephone and the at least one additional remote cellular receiver can communicate only with the at least one additional remote cellular receiver.

8. The telephone system of claim 6, wherein the remote cellular receiver and the at least one additional remote cellular receiver each communicate with only either the cellular telephone or the at least one additional cellular telephone.

9. The telephone system of claim 1, further comprising a plurality of remote cellular receivers.

10. The telephone system of claim 9, wherein each of the plurality of remote cellular receivers lack an ability to initiate a telephone call.

11. The telephone system of claim 1, wherein the at least one remote cellular receiver further includes an antennae that receives a RF signal carrying voice data originating from the cellular telephone.

12. The telephone system of claim 11, wherein the at least one remote cellular receiver further includes a base that receives the handset.

13. The telephone system of claim 11, wherein the handset further comprising an assembly that converts the RF signal into a voice signal.

14. The telephone system of claim 11, wherein the at least one remote cellular receiver further includes a base that receives the handset, the base further comprising an antennae that receives a RF signal carrying voice data originating from the cellular telephone.

15. The telephone system of claim 14, the handset further comprising a cord attaching the handset to the base, the handset including a speaker assembly that converts the RF signal into a voice signal.

16. The telephone system of claim 1, wherein the at least one remote cellular receiver forms a plurality of receivers and each of the plurality of receivers can communicate with only the cellular telephone and each receiver of the plurality of receivers.

17. The telephone system of claim 16, further comprising coordinating circuitry permitting each of the plurality of receivers to simultaneously communicate with the cellular phone.

18. The telephone system of claim 17, further comprising a second cellular telephone and a second set of remote cellular receivers.

19. The telephone system of claim 18, wherein the coordinating circuitry communicates with the cellular telephone, second cellular telephone, plurality of receivers and second set of remote cellular receivers.

20. The telephone system of claim 19, the plurality of receivers and second set of remote cellular receivers each including a plurality of switches controlling a line of communication from one receiver of the plurality of receivers or second set of receivers to one of the cellular telephone or second cellular telephone.
